(19) United States
(12) Patent Application Publication
(10) Pub. No.: US 2004/0244054 A1
(43) Pub. Date: Dec. 2, 2004

(54) Multimedia play television

(76) Inventors: Joe Sheu, Hsin-Chu (TW); Pc Huang, Hsin-Chu (TW); Js Chen, Hsinchu (TW); Frank Kao, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/699,929

(22) Filed: Nov. 4, 2003

(30) Foreign Application Priority Data
May 30, 2003 (TW) 92209970

(51) Int. Cl. H04N 7/173; H04N 7/16; H04N 3/27

(52) U.S. Cl. 725/131; 725/139; 725/151

(57) ABSTRACT

A multimedia play television is proposed, wherein a central processor, a television signal receiver, a memory card slot, and an optical disc read/write device connected with the central processor are integrated together. The central processor processes television signals received by the television signal receiver and plays them on the television. The central processor controls actions of the memory card slot and the optical disc read/write device to let read data in a memory card or an optical disc be played on the television. The proposed television can read memory cards and optical discs, and makes use of a single central processor to process multimedia audio/video data to accomplish multiple selections of entertainments, convenient use and less occupied space.

### FIELD OF THE INVENTION

The present invention relates to a television and, more particularly, to a television capable of playing multimedia to integrate play media for read of memory cards and optical discs.

### BACKGROUND OF THE INVENTION

Along with the continual progress of the information technology, various kinds of electronic information products like mobile phones, notebook computers, DVD players and digital cameras provide different applications such as audio/video multimedia and data transmission via network in everyday lives of people. Conventional players like DVD players, MP3 players or card readers are separate devices. In order to meet multimedia play of modern people, play tools integrating several kinds of play media have been developed.

On the other hand, televisions become the most important electronic product in everyday life. They can transmit messages largely and fast, are not limited by distance, and are used for watching various kinds of programs to absorb new knowledge and know the latest news. Entertainments programs are even the most important pastimes of many people. However, televisions are only used for watching television programs. If one wants to use a television for watching audio/video data in a DVD disc or a memory card, he needs to externally connect a DVD player or a card reader to the television. For people more and more appreciating the quality of life, the connection of many electronic devices will occupy much space. Also, many entangled electric wires are annoying.

Accordingly, the present invention aims to propose a multimedia play television to solve the problems and inconvenience in the prior art.

### SUMMARY AND OBJECTS OF THE PRESENT INVENTION

The primary object of the present invention is to provide a multimedia play television, wherein memory card and optical disc read media are integrated in a television, and a single central processor is used for processing multimedia audio/video data to expand the usage of the television, thereby accomplishing the effect of multiple selections of entertainments by using a television.

Another object of the present invention is to propose a multimedia play television to accomplish the function of multimedia play without the need of external connection with a card reader or an optical disc player, thereby accomplishing both effects of convenience and less occupied space and also solving the inconvenience and trouble of external wire connection in the prior art.

Yet another object of the present invention is to provide a multimedia play television having a high added value so that users need not to additionally purchase a card reader or an optical disc player, hence accomplishing the advantage of a lower cost.

To achieve the above objects, the present invention comprises a television, a memory card slot, an optical disc read/write device and a central processor. The television has a television signal receiver for reception of television signals. The memory card slot is arranged in the television. The opening of the memory card slot protrudes out of the surface of the television. The memory card slot provides connection with memory cards of different specifications. The optical disc read/write device is arranged in the television, and provides placement of an optical disc and performs read/write actions to the optical disc. The central processor is arranged in the television, and is connected with the television signal receiver, the memory card slot and the optical disc read/write device. The central processor is used to process the television signals and play them on the television, and control actions of the memory card slot and the optical disc read/write device to let read data be played on the television. The central processor can thus be utilized to integrate multimedia audio/video data and play them on the television.

The various objects and advantages of the present invention will be more readily understood from the following detailed description when read in conjunction with the appended drawings, in which:

### BRIEF DESCRIPTION OF DRAWING

FIG. 1 is a structure block diagram of the present invention;

FIG. 2 is a flowchart for reading a memory card of the present invention;

FIG. 3 is a diagram showing a main menu frame of the present invention; and

FIG. 4 is a diagram showing a file list menu frame of the present invention.

### DETAILED DESCRIPTION OF PREFERRED EMBODIMENT

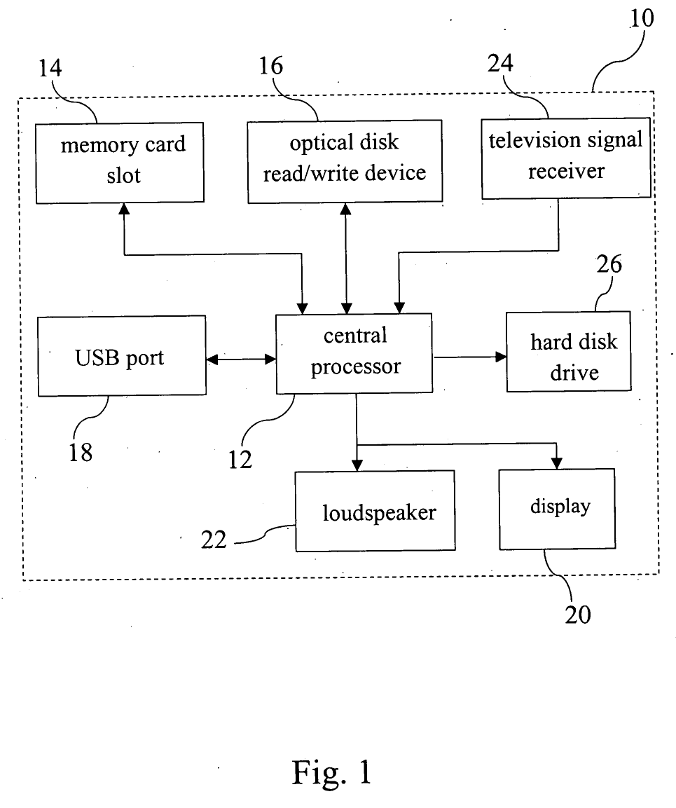

As shown in FIG. 1, a central processor 12 is provided in a television 10. The central processor 12 is used for control and integration of other components in the television 10. The central processor 12 is connected to a memory card slot 14, an optical disc read/write device 16, a USB port 18, a display 20, a loudspeaker 22, a television signal receiver 24 and a hard disk drive 26. Through these connections, the central processor 12 can process audio/video data including video files, game files, audio files, audio/video files and television signals.

The memory card slot 14 is arranged in the television 10. The opening of the memory card slot 14 protrudes out of the surface of the television 10. The memory card slot 14 provides insertion of a memory card or simultaneous insertion of two or more memory cards. Through connection of the memory card slot 14, the central processor 12 can read memory cards of different specification including secured digital (SD) cards, multimedia cards (MMC), smart media (SM) cards, memory stick (MS) cards, compact flash (CF) cards, XD-picture cards and microdrives. The optical disc read/write device 16 is arranged in the television 10, and provides placement of an optical disc, and is controlled by the central processor 12 to perform read/write actions to the optical disc. The optical disc read/written by the optical disc read/write device 16 is generally of DVD, VCD, CD or MP3 format. The USB port 18 is embedded in the surface of the television 10, and provides a USB connector for transmission of data with other electronic devices having a USB port via a USB transmission line. The display 20 and the loudspeaker 2 are controlled by the central processor 12 to display images and play sounds, respectively. The television signal receiver 24 is used to receive television signals and send them to the central processor 12 for signal processing. The processed signals are then played out by the display 20 and the loudspeaker 22 so that a user can watch television programs. The television signals are generally analog, and can also be digital.

The hard disk drive 26 is used for data storage. The central processor 12 stores data inputted from the memory card slot 14, the optical disc read/write device 16, the USB port 18, or the television signal receiver 24 into the hard disk drive 26.

Through the above structure, the central processor 12 receives and decodes the television signals from the television signal receiver 24, and then displays images with the display 20 and plays sound with the loudspeaker 22. The central processor 12 can further store the inputed television signals into the hard disk drive 26. Through the function of time shift, the user only needs to press a record key to simultaneously record the television program received by the television signal receiver 24 into the hard disk drive 26 when watching another television program. During recording, any recorded part can be read and played from the hard disk drive 26 at any time so that the user can freely determine the play time of a television program without missing any splendid frame.

On the other hand, the central processor 12 is used to control actions of the memory card slot 14 and the optical disc read/write device 16 to let the display 20 display the memory card data read by the memory card slot 14 or the optical disc data read by the optical disc read/write device 16 or the loudspeaker 22 simultaneously play sound. In other words, the central processor 12 integrates multimedia audio/video data, which are played by the television 10. Therefore, in addition to having the function of watching television programs, the television 10 proposed by the present invention has both the optical disc read/write function and memory card read/write function, and can play the read audio/video data, and can even make use of the USB port 18 for intercommunication of data with a computer. Because the principle and operation of playing the received television signals on the television 10 are well known in the prior art, only the memory card and optical disc read process of the television 10 will be exemplified below.

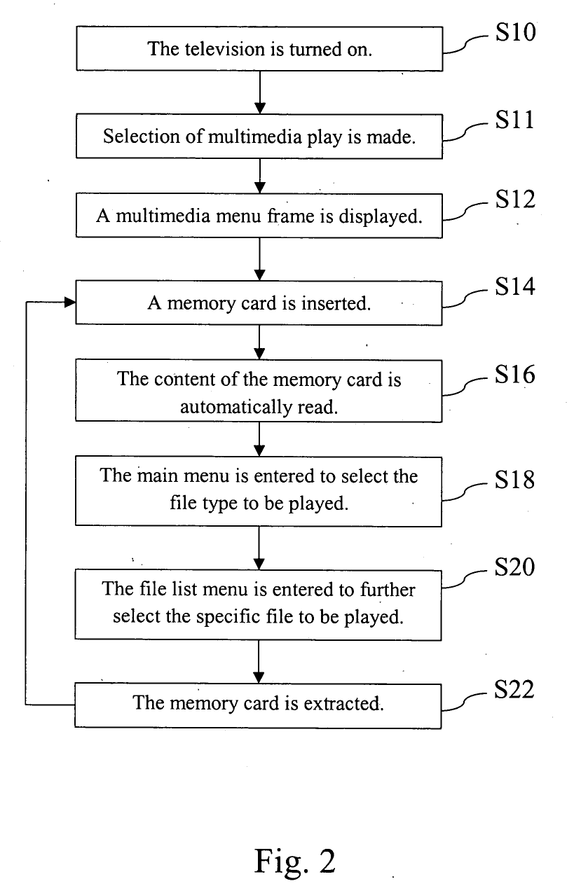

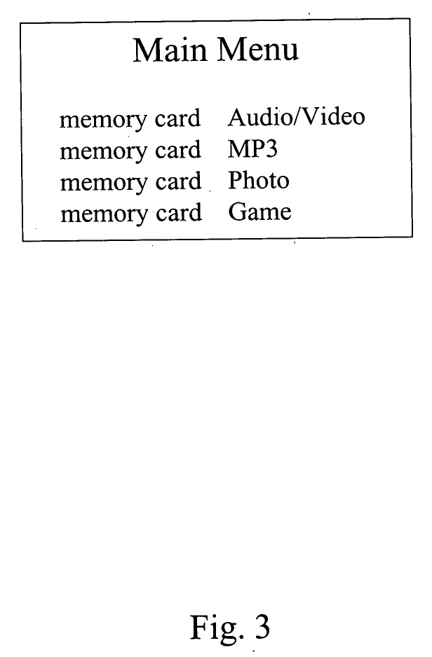

FIG. 2 shows the memory card read and play flow process. First, a user sends out a command via a key module or a remote controller to turn on the television 10 (Step S10). He then uses the remote controller to select the multimedia play function (S11), and the central processor 12 in the television 10 starts functioning to let the display 20 display a multimedia play menu frame (S12). Next, the user inserts a memory card into the memory card slot 14 (S14). The central processor 12 then automatically reads the content of the memory card and classifies files in the memory card (S16). If the memory card stores audio/video files of format supportable by the central processor 12 like DAT files, MP3 files or JPG files, the central processor 12 enters a main menu and drives the display 20 to display a main menu frame shown in FIG. 3. The user can then use the remote controller to select the file type to be played from the main menu frame displayed by the display 20 (S18).

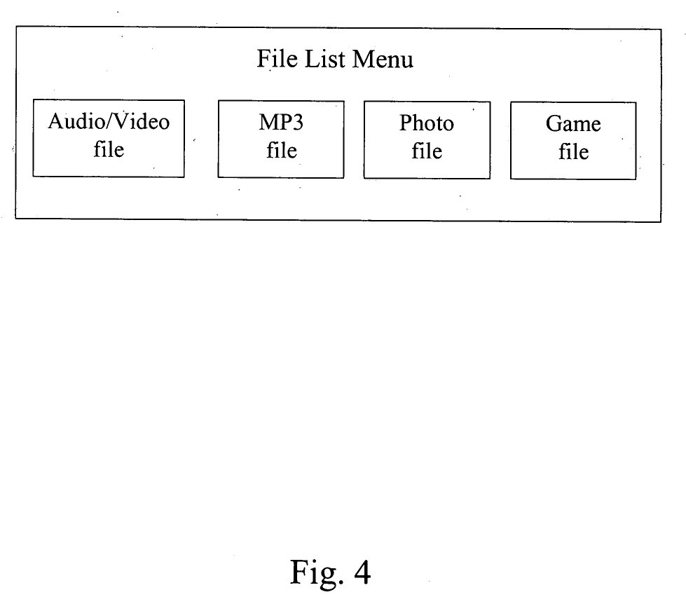

After the user selects the file type to be played, the central processor 12 enters a file list menu and drives the display 20 to display a file list menu frame shown in FIG. 4 (S20). The file list menu displays all file types in the memory card including an Audio/Video menu, an MP3 menu, a Photo menu and a Game menu. At this time, the user can further select the specific file to be played from one of these menus. If the user wants to change the memory card in operation, he can directly extracts the memory card and then inserts another memory card (S22), and repeats the above steps S14 to S20 to let the central processor 12 read the content in the memory card.

In Step 20, after the user selects the specific file to be played from one of the menus, the central processor 12 automatically reads data in the memory card and decompresses the read data, and then converts the decompressed digital data into analog audio/video signals acceptable by the display 20 and/or the loudspeaker 22. Next, the display 20 and/or the loudspeaker 22 plays the analog audio/video signals. If the display 20 and the loudspeaker 22 are digital, no signal conversion is required for the decompressed digital data, which can be directly played.

The operation process of optical disc read of the television 10 is similar. The insertion action of a memory card into the memory card slot 14 is changed to the placement action of an optical disc in the optical disc read/write device 16. The menu selection actions between the central processor 12 and the optical disc read/write device 16 are the same as in the above process and thus will not be further described. After the user selects the specific file to be played from one of the menus, the central processor 12 automatically sends a drive instruction, to the optical disc read/write device 16 to let the optical disc read/write device 16 automatically read data in the optical disc. The optical disc read/write device 16 then transfers the read audio/video data to the central processor 12 for decompression. The digital data after decompression are then converted into analog audio/video signals acceptable by the display 20 and/or the loudspeaker 22. Next, the display 20 and/or the loudspeaker 22 plays the analog audio/video signals. Similarly, if the display 20 and the loudspeaker 22 are digital, no signal conversion is required for the decompressed digital data, which can be directly played.

To sum up, the present invention integrates memory card and optical disc read media into a television, and makes use of a single central processor for processing multimedia data to expand the usage of television. The present invention provides a multimedia play television to accomplish multiple selections of entertainments items. Moreover, memory cards and optical discs can be read without the need of external connection with a card reader and an optical disc player, hence accomplishing both effects of convenient use and less occupied space. Therefore, the present invention can solve inconvenience and trouble in the prior art, and can also greatly enhance the added value of television. Users need not to additionally purchase a card reader or an optical disc player, hence simultaneously accomplishing the advantage of a lower cost.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A multimedia play television comprising:
a television having a television signal receiver for reception of television signals;
a memory card slot provided in said television, an opening of said slot protruding out of the surface of said television, said memory card slot providing connection with memory cards of different specifications; and
a central processor provided in said television and connected with said television signal receiver and said memory card slot, said central processor being used to process said television signals and play them on said television, and control actions of said memory card slot to let read data be played on said television, said central processor being utilized to integrate multimedia audio/video data and play them on said television.

2. The multimedia play television as claimed in claim 1, wherein said central processor can read memory cards of different specifications.

3. The multimedia play television as claimed in claim 1, wherein said memory card is selected among the group composed of secured digital cards, multimedia cards, smart media cards, memory stick cards, compact flash cards, XD-picture cards and microdrives.

4. The multimedia play television as claimed in claim 1, wherein an optical disc read/write device connected to said central processor is further provided in said television, said optical disc read/write device provides placement of an optical disc, and is controlled by said central processor to performs read/write actions to said optical disc.

5. The multimedia play television as claimed in claim 4, wherein the format of said optical disc read/written by said optical disc read/write device is selected among the group composed of DVD, VCD, CD and MP3.

6. The multimedia play television as claimed in claim 1, wherein a hard disk drive is further provided in said television, and is connected with said central processor.

7. The multimedia play television as claimed in claim 1, wherein said television signals are analog.

8. The multimedia play television as claimed in claim 1, wherein said television signals are digital.

9. The multimedia play television as claimed in claim 1, wherein said multimedia audio/video data processed by said central processor include video files, game files, audio files, audio/video files and said television signals

10. The multimedia play television as claimed in claim 1, wherein said central processor decompresses said read audio/video multimedia data to obtain digital data and converts said digital data into analog signals, which are then played by said television.

11. The multimedia play television as claimed in claim 1, wherein said central processor decompresses said read audio/video multimedia data to obtain digital data, which are then played by said television.

12. The multimedia play television as claimed in claim 1, wherein a USB port is further provided in said television.
